(19) United States
(12) Patent Application Publication
(10) Pub. No.: US 2024/0406243 A1
(43) Pub. Date: Dec. 5, 2024

(54) METHOD FOR DATA RATE AND BUFFER ESTIMATION FOR MULTI-SOURCE DELIVERY

(71) Applicant: Dolby Laboratories Licensing Corporation, San Francisco, CA (US)

(72) Inventors: Jason Michael CLOUD, Clayton, CA (US); Elliot OSBORNE, Neutral Bay (AU)

(73) Assignee: Dolby Laboratories Licensing Corporation, San Francisco, CA (US)

(21) Appl. No.: 18/697,260

(22) PCT Filed: Sep. 21, 2022
(86) PCT No.: PCT/US2022/044237

§ 371 Date: Mar. 29, 2024

Related U.S. Application Data
(60) Provisional application No. 63/250,930, filed on Sep. 30, 2021.

(51) Int. Cl. H04L 65/75; H04L 65/70; H04L 65/80; H04N 21/44; H04N 21/442; H04N 21/462

(52) U.S. Cl. CPC H04L 65/764; H04L 65/70; H04L 65/80; H04N 21/44004; H04N 21/44209; H04N 21/4622

(57) ABSTRACT

The present disclosure relates to a method and variable quality playback system for selecting a quality of media content. The method comprising receiving (S4001) media content of a data segment (1010) over at least one network path (1031a, 1031b, 1031c), the media content being encoded with network or application-layer code and storing (S4002) the media content in a network or application-layer decoder (1050). The network or application-layer decoder (1050) is configured to decode the media content and provide decoded media content to a buffer (5061) associated with a media renderer (1060). The method further comprises obtaining a decoding metric of the network or application-layer decoder (1050), the decoding metric indicating a property of the decoding process and selecting the quality of the media content of subsequent data segments based on the decoding metric.

### CROSS REFERENCE TO RELATED APPLICATIONS

This application claims priority to U.S. Provisional Patent Application No. 63/250,930, filed Sep. 30, 2021, the contents of which are herein incorporated in its entirety.

### TECHNICAL FIELD

The present application relates to content distribution, in particular methods and techniques for optimizing delivery of media content over a network.

### BACKGROUND

When streaming media content, such as audio and/or video content, from a remote streaming server to a client, the performance of the data link (e.g. the throughput or delay) between the server and the client will impose limits on the quality of the streamed media content. For instance, if the data rate of the data link is low, only compressed, low bitrate media content can be transmitted to the client and the resulting playback quality of the media content (e.g., the Quality of Experience or QoE), which is played back at the client will be low (e.g., the Quality of Experience or QoE is low). On the other hand, if the data rate is high, more data can be routed between the server and the client per unit of time which enables a higher play back quality (e.g., a higher Quality of Experience or QoE).

As the quality of the data link will vary from client-to-client, server-to-server and over time, streaming systems often used Adaptive Bitrate (ABR) techniques which permit the bitrate of the streamed media content to be modified (e.g., selected dynamically) depending on the instantaneous performance of the data link. In principle, ABR streaming systems enable the highest possible QoE, which is allowed by the current data link performance, to be used at all times.

Playback quality selection in traditional ABR streaming systems is typically a two-step process where a content provider encodes media content into several different qualities and communicates the available qualities and/or bitrates to a client via a content manifest. The client then selects a quality and/or bitrate from the content manifest and downloads media content with the selected quality and/or bitrate for playback. The selection process is typically influenced by several factors. For instance, factors such as client playback characteristics and user preferences help to narrow down the list of possible qualities but ultimately, the performance of the data link (e.g. the throughput, jitter, and delay) is estimated and a play back quality (e.g., resolution, bitrate, framerate, etc.) which maximizes the QoE given the estimated data link performance is selected by the client. In existing approaches, data link performance is estimated based data arriving at the client or the amount of content available in the play back buffer.

### SUMMARY

A problem with ABR techniques is that the performance of the data link is difficult to estimate accurately, especially when the media content is delivered in intermittently arriving chunks or over a connection with high jitter, which leads to an incorrect media content quality and/or bitrate being selected.

It is a purpose of the present disclosure to provide a method and variable quality media system for more accurately selecting a media content quality.

According to a first aspect of the present invention there is provided a method for selecting a quality of media content. The method comprises receiving media content of a data segment over at least one network path, the media content being encoded with network or application-layer code and storing the media content in a network or application-layer decoder. The network or application-layer decoder (sometimes referred to as a decoder) is configured to decode the media content and provide decoded media content to a buffer associated with a media renderer. The method further comprises obtaining a decoding metric of the network or application-layer decoder, the decoding metric indicating a property of the decoding process, and selecting the quality of the media content of subsequent data segments based on the decoding metric.

In some embodiments, a network path includes a communication link between a network source (e.g. a media content server) and the client device. A network path may include two or more communication links and at least one intervening device with an established communication link to one of the network source and the client device. For example, a network path may comprise a first intervening device communicating with the network source over a first communication link and with the client device over a second communication link. Additionally, at least one additional intervening device may be operating between the network source and the first intervening device (dividing the first communication link into two or more sub-links) or at least one additional intervening device is operating between the client device and the first intervening device (dividing the first communication link into two or more sub-links). The intervening device(s) may be any device suitable for acting as a node in a network, for instance the intervening device(s) is a gateway, modem, router, switch etc. Each communication link or sub-link in a network path may be a wireless link or a wired link.

The network source stores media content in different qualities (or extracts the different qualities on-demand via for example, transcoding) and transmits media content of a selected quality to the client device over at least one network path. The transmitted media content (e.g., media content encoded) is encoded with a network or application-layer code which must be decoded to obtain decoded media content, wherein the decoded media content is in a format which can be ingested by the media renderer. For the decoded media content the network or application-layer encoding has been decoded. The decoded media content may still be in a media encoded format which can be ingested and processed by the media renderer. Examples of media encoding formats which can be ingested by the media renderer are H.266/VVC. H.265/HEVC, H.264/AVC, MPEG-2, VP8, VP9, AV1, AAC, MP2, Opus, etc. Accordingly, the encoded media content may comprise two levels of encoding, media encoding encapsulating the original media content, and network or application-layer encoding encapsulating the media encoded original media content.

The original media content is segmented (and optionally media encoded) into a plurality of blocks, wherein each block represents a portion (e.g. a predetermined duration) of the original media content and wherein each block is encoded with a network or application-layer code to form a corresponding encoded data segment (which carries an encoded representation of the media content block). The network or application-layer code is code suitable for dividing a data element into a plurality of sub-elements which can be transmitted over a plurality of different network paths and reassembled at the destination (i.e. the client device). The network or application-layer code may be code which divides a data element into a plurality of linearly independent symbols. The network or application-layer code may be a linear code or a non-linear code. For example, the network or application-layer code may be RaptorQ code, Reed-Solomon code, Luby Transform code, Random Linear Network code or the like.

In some embodiments, a media renderer includes any type of renderer which obtains media content and renders the media content. Rendering media content entails processing the media content to obtain media content in a presentation-ready format. The presentation-ready format is adapted to be fed to a display device and/or loudspeaker for visual or acoustic presentation. For instance, a video renderer processes media content and produces a video frame which can be presented on a display device. In some implementations, the media renderer is a media player or client media application configured to obtain audio and/or video content and render the audio and/or video content. Further, the media renderer in some embodiments is used to render media for a gaming application, AR/VR/XR application, video and/or audio conferencing application etc. In some implementations, the media renderer provides the rendered media content to a presentation device for acoustic or visual presentation. The presentation device may e.g. comprise a display and/or a loudspeaker.

In some embodiments, selecting quality of media content includes selecting a Quality of Experience, QoE, of the media content. The selected media content quality may be represented with a value, e.g. indicating a selected bit-rate or data segment size. The selected media content quality may be represented with a descriptive label, such as high quality, medium quality, and low quality, or a resolution such as ultra high-definition (UHD), high-definition (HD) or standard-definition (SD). As further examples, the selected media content quality may indicate an audio sampling rate, media encoding format or level of compression of the media content.

It is well understood that the same media content may be represented at a variety of QoE levels where higher levels offer perceptually higher quality at the cost of more data being required to represent a certain duration of media content, i.e. a higher bitrate.

The present invention is at least partly based on the understanding that by obtaining a decoding metric and selecting the media quality based on the decoding metric a more accurate selection of the media content quality is made. As the media content is delivered in encoded data segments, which must be decoded prior to being provided to the media renderer, a metric e.g. indicating the rate at which decoded media content is delivered to the buffer or the amount of decoded content present in the buffer associated with the media renderer, would not be an accurate basis for making media content selections. For example, the traffic shape/pattern downstream of the network or application-layer decoder does not reflect the shape/pattern of the data received by the decoder. Instead, data traffic downstream of the network or application-layer decoder tends to move in bursts where large and irregular bulk deliveries of data is transferred from the network or application-layer decoder to the buffer associated with the media renderer. This may lead to overestimates of the size of the network jitter resulting in more conservative ABR behavior e.g., longer startup times, lower playback quality. With the present invention, the decoding process of the network or application-layer decoder is considered via the decoding metric, which enables a more accurate selection of media content quality.

In some implementations, the media content is received over at least two different network paths. As the media content is encoded with a network or application-layer code the media content of a same data segment may be transmitted to the client device over two or more different network paths in parallel. A first network path is different from a second network path if the first network path involves a communication link which is not found in the second network path. A network path may be described as a directed graph path with the network source, optional intervening devices and the client device constituting graph vertices and the communication links constituting graph edges. Two network paths are different if they involve different sets of vertices and/or different sets of edges. As an example, a first network path involving a single communication link from the network source to the client device is different from a second network path involving two communication links and one intervening device. Using two or more network paths to stream encoded media content to the client device is beneficial for several reasons. For example, with two or more network paths the reliability and bandwidth are increased and the robustness to source and/or connection failures is enhanced. As a further example, with two or more network paths the mean-weighted throughput variance of the media content decreases to provide a more dependable quality of service (QOS).

In some embodiments, at least two network paths may connect to the same network source. In some embodiments, at least two network paths connect to different network sources with each network source conveying a portion of the media content to the client device. That is, each network source is associated with at least one, but optionally two or more, network paths to the client.

In some implementations, the decoding metric indicates an estimated time until the data segment has been fully received and/or decoded by the network or application-layer decoder.

The time until the data segment has been fully received and/or decoded is indicative of when the media content of the data segment will be available in a decoded format which can be ingested by the media renderer. Accordingly, if the time until the data segment has been fully received and/or decoded exceeds a threshold time a lower quality of the media content may be requested and if the time until the data segment has been fully received and/or decoded is below a threshold time the quality of the media content may be increased.

In some implementations, the media content of the data segment comprises a first number of symbols and the method further comprises determining, for each network path, a waiting time between two consecutive received symbols received from the network path, and determining the estimated time using a renewal process based on an expected time for receiving a predetermined number of symbols with the determined waiting time(s) and a predetermined confidence level. In some implementations, the predetermined number of symbols is equal to or greater than the first number of symbols.

That is, each data segment carrying an encoded media content block is divided into a plurality of portions, called symbols. The symbols are transmitted over the one or more network paths and stored in the network or application-layer decoder. When the network or application-layer decoder has received a sufficient number of symbols to start the decoding process, the data segment is decoded to obtain the decoded media content block.

The inventors have realized that the arrival of symbols at the network or application-layer decoder may be modelled as a renewal process (e.g. a Poisson process) for each of the one or more network paths. Accordingly, the estimated time until the entire data segment has been received and/or decoded may be based on the expected time for receiving a predetermined number of symbols with the one or more renewal processes associated with each of the one or more network paths.

In some implementations, the decoding metric indicates a data rate at which media content of the data segment is received and an amount of overhead of the media content. Wherein the method further comprises determining a goodput data rate based on the data rate of the media content and the amount of overhead, the data rate at which the encoded media content is received being higher than the goodput data rate of the decoded data, and determining the decoding metric based on the goodput data rate.

As the data segments are encoded, they contain both the original media content (i.e. the goodput) as well as coding overhead (such as received linearly dependent symbols or coding headers). To extract a more accurate measure of the data rate at which decoded media content is received the raw data rate of encoded data is used together with the decoding metric, which indicates at least the overhead of the encoded media content, to determine goodput data rate which provides a more accurate basis for selecting the media content quality.

According to a second aspect of the invention there is provided a variable quality media system comprising a network or application-layer decoder configured to receive media content of a data segment over at least one network path and store the media content, the media content being encoded with network or application-layer code, and a media renderer, associated with a buffer. The variable quality media system further comprises a media quality selector, configured to obtain a decoding metric of the network or application-layer decoder and select a quality of the media content of subsequent data segments based on the decoding metric, the decoding metric indicating a property of the decoding process, wherein the network or application-layer decoder is further configured to decode the media content and provide decoded media content to the buffer.

According to a third aspect of the invention there is provided a non-transitory computer-readable storage medium storing one or more programs configured to be executed by one or more processors of an electronic device. The one or more programs including instructions for receiving media content of a data segment over at least one network path, the media content being encoded with network or application-layer code and storing the media content in a network or application-layer decoder, the network or application-layer decoder being configured to decode the media content and provide decoded media content to a buffer associated with a media renderer. The one or more programs further including instructions for obtaining a decoding metric of the network or application-layer decoder, the decoding metric indicating a property of the decoding process and selecting the quality of the media content of subsequent data segments based on the decoding metric.

According to a fourth aspect of the invention there is provided a variable quality media system comprising means for receiving media content of a data segment over at least one network path wherein the media content being encoded with network or application-layer code and means for storing the media content in a network or application-layer decoder, the network or application-layer decoder being configured to decode the media content and provide decoded media content to a buffer associated with a media renderer. The system further comprises means for obtaining a decoding metric of the network or application-layer decoder, the decoding metric indicating a property of the decoding process and means for selecting the quality of the media content of subsequent data segments based on the decoding metric.

According to a fifth aspect of the invention there is provided a computer program product comprising instructions that, upon execution by one or more processors, cause the one or more processors to perform the method of the first aspect of the invention.

The invention according to the second, third, fourth and fifth aspects features the same or equivalent benefits as the invention according to the first aspect. Any functions described in relation to a method, may have corresponding features in a system and vice versa.

### BRIEF DESCRIPTION OF THE DRAWINGS

The present invention will be described in more detail with reference to the appended drawings, showing currently preferred embodiments of the invention.

FIG. 1a illustrates original media content blocks which are encoded into respective data segments at varying quality levels, according to some implementations.

FIG. 1b illustrates a variable quality media system communicating with a plurality of network sources over a plurality of network paths according to some implementations.

FIG. 1c depicts schematically a data segment carrying media content encoded with a network or application-layer code according to some implementations.

FIG. 2 depicts exemplary graphs showing examples of how data segment symbols are received as a function of time according to some implementations.

FIG. 3 illustrates variable quality media system for selecting a media content quality based on a decoding metric according to some implementations.

FIG. 4 is a flowchart describing a method for selecting a media content quality according to some implementations.

FIG. 5 illustrates variable quality media system for selecting a media content quality based on a decoding metric and a media renderer metric according to some implementations.

FIG. 6 illustrates the duration of decoded media content relative the duration of received encoded media content and encoded media content which has yet to be received, according to some implementations.

FIG. 7 depicts exemplary graphs showing the estimated time for when a complete data segment has been received as function of how many symbols of the data segment that have been received, according to some implementations.

### DETAILED DESCRIPTION

Systems and methods disclosed in the present application may be implemented as software, firmware, hardware or a combination thereof. In a hardware implementation, the division of tasks does not necessarily correspond to the division into physical units: to the contrary, one physical component may have multiple functionalities, and one task may be carried out by several physical components in cooperation.

The computer hardware may for example be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions (sequential or otherwise) that specify actions to be taken by that computer hardware. Further, the present disclosure shall relate to any collection of computer hardware that individually or jointly execute instructions to perform any one or more of the concepts discussed herein.

Certain or all components may be implemented by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system (i.e. a computer hardware) that includes one or more processors. Each processor may include one or more of a CPU, a graphics processing unit, and a programmable DSP unit. The processing system further may include a memory subsystem including a hard drive, SSD, RAM and/or ROM. A bus subsystem may be included for communicating between the components. The software may reside in the memory subsystem and/or within the processor during execution thereof by the computer system.

The one or more processors may operate as a standalone device or may be connected, e.g., networked to other processor(s). Such a network may be built on various different network protocols, and may be the Internet, a Wide Area Network (WAN), a Local Area Network (LAN), or any combination thereof.

The software may be distributed on computer readable media, which may comprise computer storage media (or non-transitory media) and communication media (or transitory media). As is well known to a person skilled in the art, the term computer storage media includes both volatile and non-volatile, removable and non-removable media implemented in any method or technology for storage of information such as computer readable instructions, data structures, program modules or other data. Computer storage media includes, but is not limited to, physical (non-transitory) storage media in various forms, such as EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by a computer. Further, it is well known to the skilled person that communication media (transitory) typically embodies computer readable instructions, data structures, program modules or other data in a modulated data signal such as a carrier wave or other transport mechanism and includes any information delivery media.

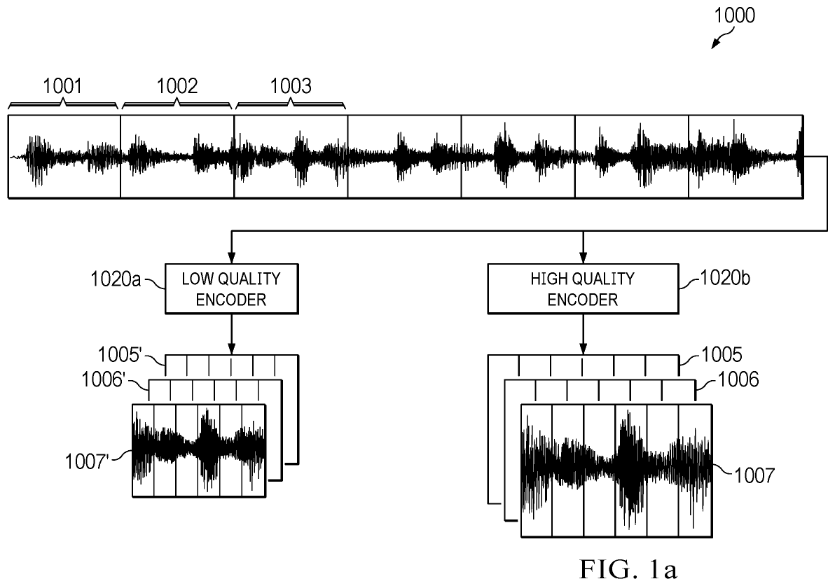

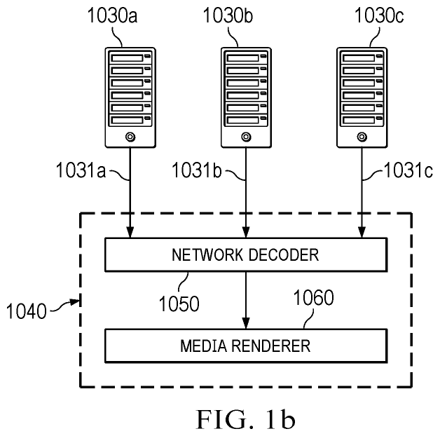

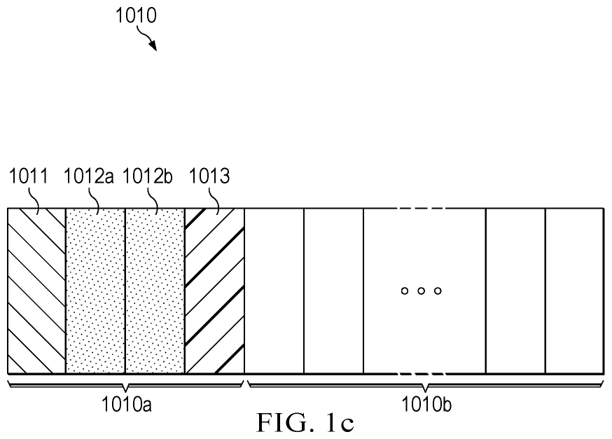

In FIG. 1a the extraction of a data segment 1005, 1006, 1007, 1005′, 1006′, 1007′ carrying network or application-layer encoded media content is illustrated. Original media content 1000 is divided into a plurality of consecutive media content blocks 1001, 1002, 1003. It is envisaged that each media content block 1001, 1002, 1003 is of equal duration. That is, each media content block 1001, 1002, 1003 represents a set duration of media (e.g. 1 second or 500 milliseconds) of media.

The media content blocks 1001, 1002, 1003 may be represented at different quality levels, e.g. by being encoded with different media encoding formats (such as H.264 or H.265) at different quality levels. For instance, if the original media content 1000 is a high resolution video content (e.g. UHD), it may be represented at one or more lower resolutions (e.g. HD or SD) and/or at different compression levels. In the embodiment depicted in FIG. 1a, the media content blocks 1001, 1002, 1003 are encoded into high quality data segments 1005, 1006, 1007 and low quality data segments 1005′, 1006′, 1007′ by the low quality encoder 1020a and the high quality encoder 1020b respectively. The low quality encoder 1020a and high quality encoder 1020b may be realized as a single encoder which can switch between different media content qualities. For example, the low quality encoder 1020a may be configured to encode the original media content with a low quality media encoder (e.g. H.264 at HD resolution) and then encode the low quality media content with network or application-layer code whereas the high quality encoder 1020b may be configured to encode the original media content with a higher quality media encoder (e.g. H.264 at UHD resolution) and then encode the high quality media content with network or application-layer code.

The corresponding high and low quality data segments 1005, 1006, 1007, 1005′, 1006′, 1007′ represent the same media content, only at different levels of quality (QoE), and the data segments may thus have different data sizes depending on the level of quality of the encoded media content. The high quality data segments 1005, 1006, 1007 may comprise a larger number of data segment symbols and/or larger symbols compared to the low quality data segments 1005′, 1006′, 1007′. For instance, the same media content block 1001, 1002, 1003 may be represented with high quality using a data segment comprising 255 symbols of 20 kB each (giving a total segment size of about 5 MB) or with low quality using a data segment comprising 64 symbols of 5 kB each (giving a total segment size of about 300 kB). Once decoded and rendered, the QoE of the media content associated with high quality data segment will be higher compared to the low quality data segment.

In FIG. 1a only two media content qualities are depicted, however it is understood that any media content 1000 may be represented at an arbitrary number of different qualities. Wherein the different qualities of media content e.g. differ in at least one of: resolution, compression, bitrate, media encoding format and frame size.

It is also envisaged that the duration of the media content blocks 1001, 1002, 1003 may vary from one media content block to another and/or that the media content blocks are partially overlapping.

The encoding of the original media content 1000 into different qualities may occur in a network source whereby the encoded media content (which is also encoded with the network or application-layer code) is stored or transmitted to client in the form of data segments 1005, 1006, 1007, 1005′, 1006′, 1007′ with the media content quality being selected or requested by the client.

FIG. 1b illustrates a client 1040 receiving encoded media content from one or more network sources 1030a, 1030b, 1030c over one or more network paths 1031a, 1031b, 1031c. The client 1040 comprises a network or application-layer decoder 20, configured to receive encoded media content and decode the encoded media content so as to obtain decoded media content in a format (e.g. an encoded format H.265) which is ingestible by the media renderer 1060.

In traditional streaming of media content, a single network source 1030a, 1030b, 1030c transmits the media content in an ingestible format directly to a media renderer 1060 (e.g. a media player) which renders the media content. However, in the embodiment depicted in FIG. 1a and FIG. 1b the ingestible media content is encoded with network or application-layer code, which the media renderer 1060 cannot process, prior to being transmitted from the network source 1030a, 1030b, 1030c to the client 1040 over one or more network paths 1031a, 1031b, 1031c. The network or application-layer decoder 1050 of the client 1040 decodes the encoded media content, so as to obtain decoded media content and then provides the decoded media content to the media renderer 1060.

The media content may be encoded with any suitable network code or application-layer code. The media content may be encoded with linear or non-linear code. For example, the media content may be coded with linear codes such as RaptorQ, Reed-Solomon, Luby Transform, Random Linear Network Codes, any non-linear code or other suitable code types.

While network or application-layer code adds a layer of encoding (which must be decoded prior to rendering) the usage of a network or application-layer code allows the media content to be received from more than one network source 1030a, 1030b, 1030c (e.g. in parallel) or from a single network source 1030a, 1030b, 1030c over a plurality of different network paths 1031a, 1031b, 1031c. For example, the media content is received over at least two network paths 1030a, 1030b, 1030c which facilitates enhanced bandwidth, lower latency and higher reliability for the streaming of the media content from the network source(s) 1030a, 1030b, 1030c to the client device 1040. As a further example, the media content is received from at least two network sources, wherein each network source is associated with at least one network path to/from the client 1040.

In some implementations, the original media content is divided into a plurality of consecutive media content blocks, wherein each media content block is encoded with network or application-layer code to form a network or application-layer encoded data segment. The data segment may be encoded by the network source(s) 1030a, 1030b, 1030c prior to being transmitted the client device 1040 over the network path(s) 1031a, 1031b, 1031c.

As seen in FIG. 1c, each data segment 1010 may be divided into a predetermined number of symbols. The predetermined number of symbols may be any integer greater than or equal to two. The predetermined number of symbols may be the same for all data segments or vary from one segment to the next data segment. For instance, the predetermined number of symbols is between 10 and 1000, or preferably between 50 and 255. In FIG. 1c, a set 1010a of the symbols has already been received and stored in the network or application-layer decoder 1050 while the remaining symbols 1010b of the data segment 1010 are being received or are yet to be received.

If only one network source 1030a transmits media content to the client device 1040 all symbols are received from the same network source 1030a. On the other hand, if two or more network sources 1030a, 1030b, 1030c transmit the media content to the client device 1040 at least one symbol of the data segment will be received from each of the network sources 1030a, 1030b, 1030c. Similarly, if one network source 1030a, 1030b, 1030c transmit the media content to the client device 1040 over at least two different network paths, at least one symbol of the data segment will be received over each of the at least two network paths.

In the example shown in FIGS. 1b and 1c, three network sources 1030a, 1030b, 1030c cooperate to transmit media content to the client device 1040 over a respective network path 1031a, 1031b, 1031c. For the data segment 1010 in FIG. 1c one symbol 1011 has been received from a first network source 1030a, two symbols 1012a, 1012b have been received from a second network source 1030b and a third symbol 1013 has been received from a third network source 1030c. These received symbols constitute the received portion 1010a of the data segment 1010 while the remaining symbols of the data segment 1010 constitute a yet to be received portion 1010b of the data segment 1010.

In general, all symbols of the data segment 1010 must be received and stored in the network or application-layer decoder 1050 before the data segment 1010 can be decoded and the associated decoded media content forwarded to a media renderer. On the other hand, in some implementations a subset of the symbols of the data segment 1010 may be decoded independently of the rest of the data segment 1010. For example, once a predetermined set of symbols has been received by the decoder 1050 these symbols form a decodable sub-segment which, once decoded, will be represent a part of the media content associated with the data segment 1010. That is, a data segment 1010 comprising a decodable sub-segment may be seen as two data segments, the two data segments sharing at least one common symbol.

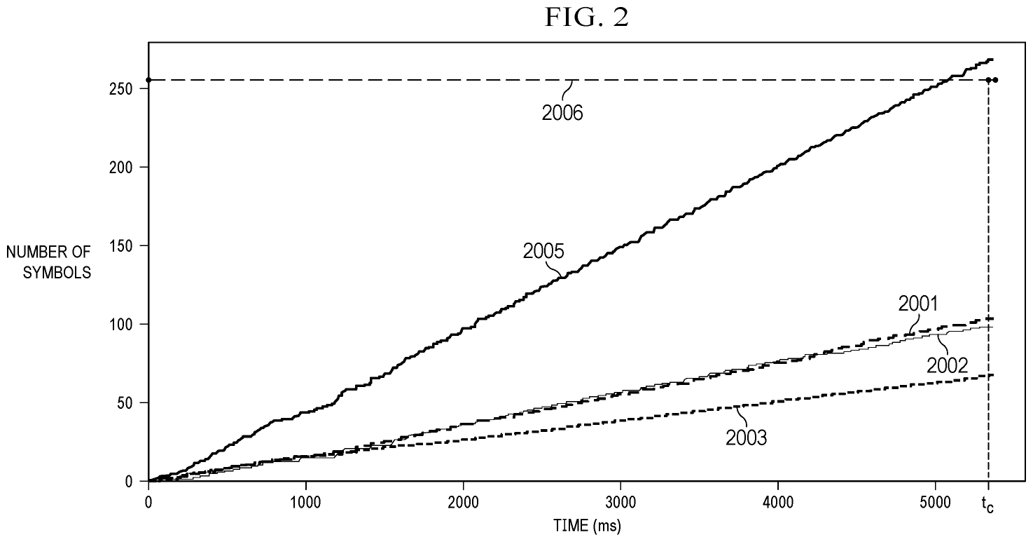

FIG. 2 is a graph illustrating how the 255 symbols of an exemplary data segment is received over three different network paths. Graph 2001, 2002 and 2003 illustrates the accumulated number of symbols over time which are received over each of the three different network paths and stored in the network or application-layer decoder. For example, it is noted that the rate at which symbols are received from each network path is not constant and may vary over time. Additionally, symbols may be received at different rates over the different network paths and in the example of FIG. 2 it is noted that symbols received over network paths associated with graph 2001 and 2002 are received at a higher average rate than the symbols received over the network path associated with graph 2003. Graph 2005 illustrates the total number of accumulated symbols received and stored in the decoder as a function of time, i.e. the sum of graphs 2001, 2002, 2003 at each instance of time.

In the example illustrated, the time, t_{c}, for completely receiving all 255 symbols required to decode the data segment is approximately 5200 milliseconds. However, it is understood that depending on the rate at which symbols are received over each network path, the number of collaborating network paths or network sources, the number of symbols and the size of each symbol the time t_{c} may vary and may even be orders of magnitude lower or higher than this example.

The threshold 2006 indicates when 255 symbols have been received and it is especially noted that the total number of accumulated received symbols exceeds 255 with some margin when the is reached. In the example shown, this is due to one or more linearly dependent symbols having been received by the network or application-layer decoder wherein the linearly dependent symbols does not aid the network or application-layer decoder in decoding the data segment. Accordingly, for each linearly dependent symbol which is received one additional symbol (which is linearly independent from the prior received symbols) must be received in addition to the predetermined number of symbols of the data segment. In other words, the more linearly dependent symbols the client device receives, the more symbols it must receive before all linearly dependent symbols required to start the decoding of the data segment have been obtained.

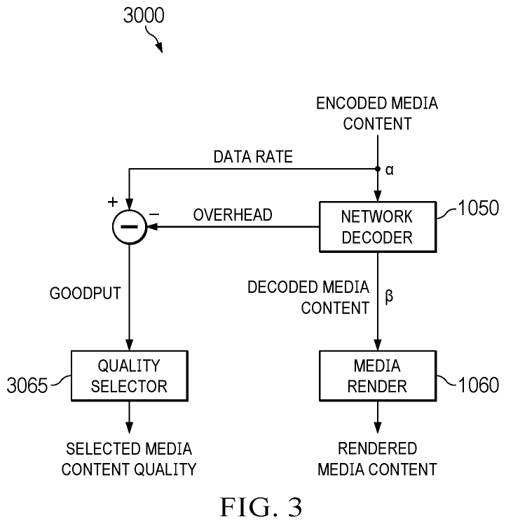

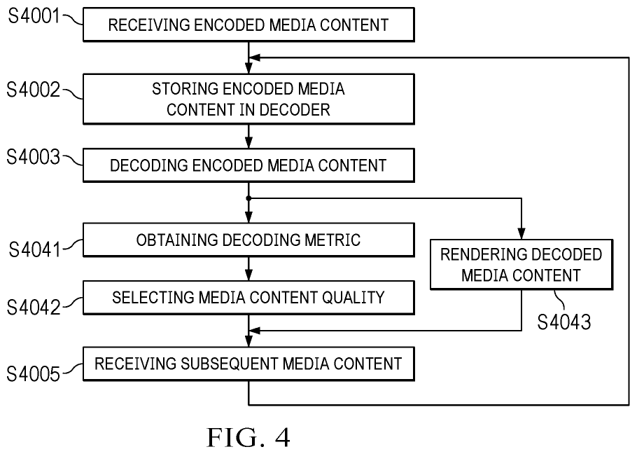

FIG. 3 illustrates a variable quality media system 3000 according to some implementations and FIG. 4 is a flowchart illustrating a method for selecting a media content quality. With a variable quality media system it is meant a system which is configured to receive data segments, decode data segments, render decoded media content of the data segments and dynamically adjust (select) the media content quality based on at least a property of the decoding process (i.e. a decoding metric).

The variable quality media system 3000 comprises a network or application-layer decoder 1050 and a media renderer 1060 (e.g. of a client media application), wherein the media renderer 1060 is configured to render the decoded media content output by the network or application-layer decoder 1050. In some implementations, the decoded media content is media encoded with any type of standard media coding (e.g. H.265) and the media renderer 1060 is configured to decode the layer of media encoding. The variable quality media system 3000 further comprises a media quality selector 3065 and the media quality selector 3065 may be any type of media quality selector. For example, the media quality selector 3065 is configured to select a QoE (e.g. a bitrate) of the media content based on a measurement of the data rate at which media content is provided to the media player 1060. The media quality selector 3065 may e.g. enable the client to retrieve or request media content of the selected quality from the network source(s) for subsequent data segments (media content blocks). In some implementations, the media quality selector 3065 selects the quality from a content manifest obtained from the network source, wherein the content manifest describes at least two available media content qualities.

With the variable quality media system 3000, a data segment carrying encoded media content is being received at S4001 and stored in the network or application layer decoder 1050 at S4002. The network or application-layer decoder 1050 decodes the encoded media content at step S4003 and provides the decoded media content to the media renderer 1060 which renders the media content and optionally decodes any media encoding encapsulated in the network or application-layer code.

Conventionally, when the media content is conveyed in a playback ready format from a single network source directly to the media renderer 1060, the data rate measured at point β is a good indication of the data rate at which decoded media content is received and sufficient information for the media quality selector 3065 to make a proper selection of the media content quality. However, in the system of FIG. 3 the data traffic at point β lies downstream of the network or application-layer decoder 1050 and has a traffic shape/pattern that does not reflect the traffic shape/pattern of the data received from the network. Instead, the traffic shape/pattern at β tends to be very bursty in the sense that large bulk deliveries of data are transferred from the network or application-layer decoder 1050 to the media renderer 1060. Accordingly, selecting media content quality based on the data rate at point β overestimates the size of the jitter also resulting in more conservative media content quality selection.

Conversely, if the data rate of the encoded media content at point α is taken as the estimate of the data rate which is provided to the media quality selector 3065 the resulting quality selections will be based on an overestimate of the bandwidth available to receive media content. For example, the rate at which bytes are received measured at point a includes all packet headers or linearly dependent symbols of the encoded data segments, which does not alter the number of degrees of freedom the network or application-layer decoder 1050 has received.

To this end, a decoding metric is obtained (e.g. from the network or application-layer decoder 1050) at S4041, the decoding metric indicating a property of the decoding process. The decoding is metric provided to the media quality selector 3065 wherein the media quality selector 3065 selects a media content quality at S4042 based on the decoding metric.

The decoding metric may for example indicate at least one of: an estimated time until the data segment has been fully received, an estimated time until the data segment has been decoded, how much of the data segment that has been received, how much of the data segment that is yet to be received, the data rate at which the data segment is received over one or more network paths, an estimated decoding time required to decode the data segment, an amount of encoding overhead, a number of received linearly dependent symbols, the predetermined number of symbols in the data segment, how much of the data segment that is decodable independently of the rest of data segment, a measure of the jitter of the network path(s) to the one or more network source(s), a measure of the latency of the network path(s) to the one or more network source(s) etc.

In the embodiment shown in FIG. 3, the decoding metric indicates a measure of the goodput of the network or application-layer decoder 1050. To this end, the media quality selector 3065 may be configured to make bandwidth based quality selection wherein the bandwidth is based on or equal to the goodput indicated by the decoding metric.

In some implementations, the goodput is determined based on an estimated data rate at which encoded media content is received by the decoder 1050 (e.g. measured at point α) and a measure of the overhead of the encoded media content as determined by the network or application-layer decoder 1050. The data rate of the encoded media content measured at location a may be the total data rate of all network sources or an individual data rate for each network path. The overhead may comprise at least one of coding headers, coding coefficients, the number of received linearly dependent symbols etc. The goodput data rate is equal to or lower than the data rate measured at point α, upstream of the network or application layer decoder 1050, and more accurately represents the bandwidth and/or data traffic pattern compared to the bandwidth and/or data traffic pattern at point β downstream of the decoder. For example, the goodput is determined by determining an amount/data rate of data associated with overheads and decreasing the data rate at point α with the amount/data rate associated with the overhead.

In some implementations, the goodput is further based on an estimated decoding time. If the network or application-layer decoder 1050 is capable of downloading a next data segment while a current data segment is being decoded, and the network usage is stable, such that one data segment is always in the process of downloading, the decoding time will only affect the goodput at start-up. Eventually, after a number of data segments have been received under these conditions, the decoding time will only influence the delay/latency and be of no importance for the average goodput.

However, some decoders are not capable of simultaneously downloading and decoding data segments and, more commonly, the network is not used to constantly download data segments due to a network overcapacity. In these and other situations, the decoding time will influence the goodput and therefore, in some implementations, the goodput is further based on the decoding time. In general, the goodput without considering the decoding time will be higher than the goodput when considering the decoding time and therefore it is beneficial to consider decoding time when making media quality decisions so as to not overestimate the goodput.

As an illustrative example, a decoder 1050 is considered which is receiving 2 megabyte data segments over one or more network paths at a rate of 1 megabyte per second, once the decoder 1050 has received the entire data segment the decoding process takes 1 second, and out of the 2 megabytes of the data segment, 0.5 megabytes is overhead data.

If the decoder 1050 is capable of simultaneous downloading and decoding it will take the decoder 3 seconds (2 seconds download and 1 second decoding) to obtain the first 2-0.5=1.5 megabytes of decoded media content meaning that the instantaneous goodput is 0.5 megabytes per second. However, if a data segment is always being downloaded (i.e. constant network utilization) the average goodput will approach 1.5 megabyte every 2 seconds (0.75 megabytes per second) as the decoding time becomes negligible.

On the other hand, if the decoder 1050 is incapable of simultaneous downloading and decoding and/or if the network utilization is non-constant, e.g. frequently interrupted due to network disruptions or network overcapacity (causing the decoder storage and/or media renderer buffer to become full) which forces the decoder to start and stop the downloading, the average goodput will instead approach the lower, 0.5 megabyte per second, value. Accordingly, in these cases it is beneficial to consider the decoding time when determining the goodput.

The decoding time may be constant for a given type of data segment (symbol size and number of symbols) or it may vary over time due to decoder performance variations. For example, it is envisaged that the network or application-layer decoder 1050 is implemented by a processor which is also used for other tasks (e.g. the processor of a multimedia user device such as a smartphone) and, depending on the workload of the processor, the decoding time of the decoder 1050 may vary.

The quality selected by the media quality selector 3065 will dictate the media content quality of at least one subsequent data segment. In some implementations, the media quality selector 3065 determines, based on the decoding metric that a specific media content quality should be used. At step S4005 the variable quality media system 3000 receives at least one subsequent data segment comprising encoded media content of the specific media content quality and stores the subsequent data segment in the decoder 1050 until it can be decoded and provided to the media renderer 1060 for rendering. Thus, the method may be repeated as media quality selector 3065 may repeatedly select a media content quality based on the (generally time-varying) decoding metric.

At step S4043 the decoded media content is rendered by the media renderer 1060. The rendered media content may then be outputted to a presentation device, wherein the presentation device comprises a display and/or a loudspeaker. In some implementations, the decoded media content is first stored in a buffer associated with the media renderer 1060 where decoded media content is stored while waiting to be rendered. Rendering the decoded media content may comprise decoding a layer of media encoding (e.g. H.265) encapsulating a representation of the original media content.

While the media quality selector 3065 may be implemented as a unit which is separate from the network or application-layer decoder 1050 and the media renderer 1060 it is envisaged that it may form part of the network or application-layer decoder 1050 or media renderer 1060. For example, the media renderer 1060 may be a variable quality media renderer configured to select a quality based on a bandwidth estimate, wherein the bandwidth estimate is based on the decoding metric from the network or application-layer decoder 1050.

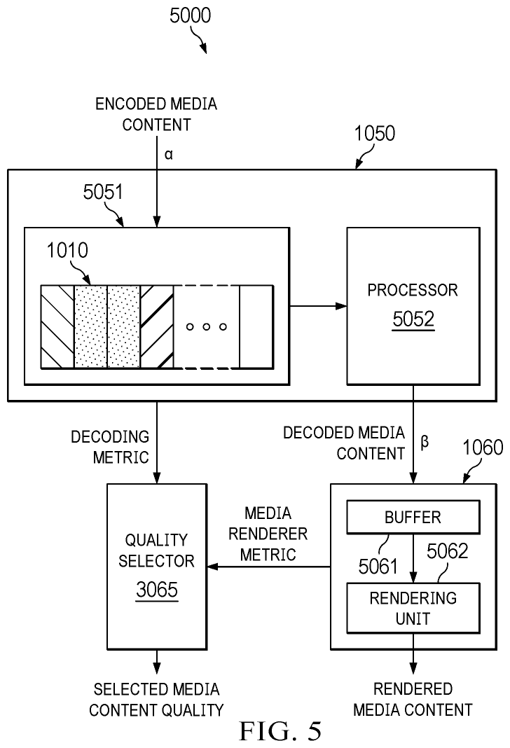

FIG. 5 depicts an alternative variable quality media system 5000 according to some implementations. The network or application-layer decoder 1050 and the media renderer 1060 may be the same as those in the embodiment depicted in FIG. 3. In FIG. 5 additional details of the application-layer decoder 1050 and the media renderer 1060 are depicted (such as the buffer 5061) and it is understood that these details may also be present in the respective modules of the embodiment in FIG. 3. The same applies also to the media quality selector 3065 although in some embodiments the media quality selector 3065 is configured to make a media quality selection based on a media render metric in addition to the decoding metric as will be described in the below.

As seen in FIG. 5, encoded media content in the form of a data segment 1010 is received by the network or application-layer decoder 1050 from at least one network source and stored (e.g. in a storage module 5051) in the network or application-layer decoder 1050. Once the complete data segment 1010 has been received, or at least once a complete decodable sub-segment has been received, a decoder processor 5052 decodes the data segment 1010 or sub-segment so as to obtain decoded media content which is conveyed to the media renderer 1060.

In some implementations, the media renderer 1060 is associated with a buffer 5061 in which the decoded media content is stored prior to the decoded media content being provided to a media rendering unit 5062 (e.g. a processor of the media renderer 1060) which renders the media content. The rendered media content is then e.g. displayed on a display device and/or used to drive one or more loudspeakers. For instance, the media content comprises video content which is rendered and displayed on a display or the media content comprises media assets for a gaming, VR, AR, and/or XR application and the media content is rendered in the gaming, VR, AR, and/or XR application.

To enable rendering of media content with the highest QoE which is allowed by the current performance of the variable quality media system 5000 and the performance of the connection to the at least one network source the media content selector 3065 is configured to select a media content quality based on at least the decoding metric as described in the above.

In some implementations, which will now be described in more detail, the media quality selector 3065 is further configured to select a media content quality based a media renderer metric of the media renderer 1060 in addition to the decoding metric. The media renderer metric indicates a property of the media rendering process of the media renderer 1060 and/or the buffer 5061. For example, the media renderer metric may indicate a property of the decoded media content which is being rendered such as the resolution, frame size, quality label, duration, media encoding format or bitrate of the decoded media content. The media renderer 1060 may e.g. be used to process the content manifest and present information, e.g. a selection of qualities, to the media quality selector 3065. Accordingly, the media renderer 1060 may provide the media renderer metric to the media quality selector 3065 to facilitate a more accurate or suitable quality selection. However, the media renderer metric is not always necessary, and it is envisaged that the media quality selector 3065 can make accurate decision based on the decoding metric obtained from the decoder 1050 as described in connection to FIG. 3 and FIG. 4 above.

The media renderer metric may for example indicate at least one of: an amount (duration) of decoded media content stored in the buffer 5061, the rate at which decoded media content is received from the network or application-layer decoder 1050, the resolution of the decoded media content, frame size of the decoded media content, quality label associated with the decoded media content, duration of the decoded media content or the bitrate of the decoded media content etc.

In some implementations, the media quality selector 3065 is configured to select a media content quality based on the duration of media content stored in the buffer 5061 (a media renderer metric) and the decoding metric of the network or application-layer decoder 20.

For instance, the decoding metric indicates an estimated time until the data segment 1010 has been fully received and/or decoded. If it is determined that the estimated time until the data segment 1010 has been fully received is below a threshold time an available amount of decoded media content is determined (e.g. by the media quality selector 3065) as the sum of the duration of the decoded media content in the buffer 5061 and the duration of the media content associated with the data segment 1010. For instance, the threshold time is the duration of decoded media content currently stored in the buffer.

The media quality selector 3065 then implements a buffer based media content quality selection based on the available amount of buffered media content.

If, on the other hand, it is determined that the estimated time until the data segment 1010 has been received exceeds the threshold time the available amount of buffered media content may be equal to only the duration of the decoded media content stored in the buffer 5061.

Thus, in some implementations, the available amount of buffered media content includes the duration of the media content associated with the data segment 1010 if it is estimated that the data segment is received before the duration of the decoded media content in the buffer 5061 has elapsed. This ensures that the media quality selector 3065 bases its selection of media content quality on an accurate measure of the amount of available media content. For example, if the time until the data segment has been received/decoded exceeds the duration of the decoded media content in the buffer 5061 the quality of media content should be decreased so as to avoid the buffer 5061 running out of decoded media content which causes the media rendering to stop abruptly.

In some implementations, a portion of the duration of the media content associated with the data segment 1010 is included in the available amount of buffered media content depending on the likelihood of the data segment 1010 being received and/or decoded before the duration of the decoded media content in the buffer 5061 has elapsed. For instance, if the likelihood of data segment 1010 being received/decoded before the duration of the decoded media content elapses is X percent, Y percent of the media content associated with the data segment 1010 will be included in the available amount of media content.

For example, X is equal to Y or at least proportional to Y. Accordingly, if it is 50% likely that the data segment 1010 is received before the duration of decoded media content in the buffer elapses 50% of the duration of the media content of the data segment is added to the duration of decoded media content in the buffer to form the available amount of media content.

To this end, the media quality selector 3065 may implement any type of buffer-based media content quality selection which is based on an amount of buffered media content, wherein the buffered media content is the available media content determined in accordance with the above.

Moreover, it is noted that the estimated time until the data segment 1010 has been received and/or decoded, or the likelihood of the data segment being received and/or decoded before the duration of the decoded media content in the buffer 5061 elapses, may be based on the data rate at which the encoded media content of the data segment 1010 is received (which may be indicated by the decoding metric).

The estimated time until the data segment 1010 has been received and/or decoded by the decoder 1050 may depend on the size of the data segment 1010 (in terms of number of symbols and amount of data). Accordingly, an estimated time required to decode the data segment 1010, i.e. an estimated decoding time, may be added to the estimated time to receive the entire data segment to form an estimated time until the data segment 1010 has been received and decoded.

The estimated decoding time depends on many parameters and, for a client device wherein the network and application-layer decoder 1060 is implemented by a device processor, these parameters include the computational power of the device (decode time is going to take longer on a device with lower-end processor than a higher-end processor), the number of symbols that are to be decoded (more non-systematic symbols increases the decode time), the total amount of data in the data segment 1010 (i.e. the size of each symbol), and other processes that are using the device processor at the time of decoding. All of these factors make estimating the time it takes to decode once enough symbols are available difficult to do in general, as the time will vary from device-to-device and from segment-to-segment.

To this end, an estimate of the decoding time may be determined on a device-to-device basis over the course of receiving and decoding several data segments 1010. The estimated decoding time for each device type may for instance be represented with a plurality of data points describing the average decoding time as a function of the number of symbols in the data segment and the total data size of the data segment. The decoding time may thus be determined by identifying a matching or closet data point and reading the associated average decoding time or interpolating between exiting data points. The decoding time estimate may be constructed, updated and stored by the client device or the decoding time estimate is managed in a database, which can be accessed by the client, in which each type of client device contributes to the decoding estimate of the corresponding type of client device.

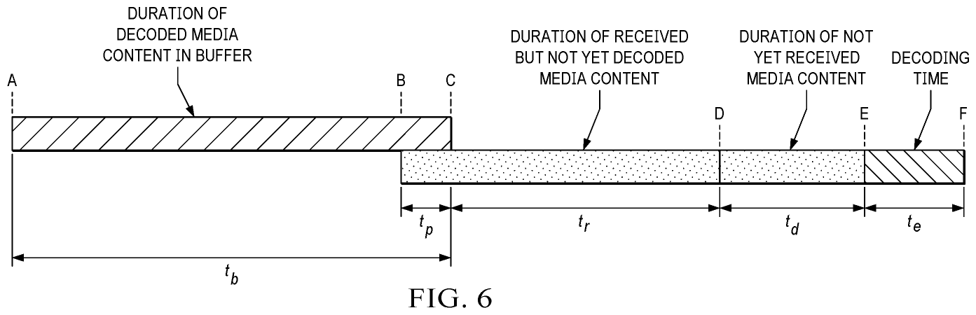

With further reference to FIG. 6 there is illustrated the duration, tᵣ+tₚ, of encoded media content stored in the network or application-layer decoder 1050 and the duration t_{b} of decoded media content stored in the buffer 5061 relative the decoding time t_{c} at a given point in time.

The duration of decoded media content stored in the buffer 5061 of the media renderer 1060, t_{b}, spans points A and C and if no new content is delivered to the buffer 31 within the time t_{b}, the buffer 5061 will run dry and content rendering will be halted. The next data segment 1010 carrying encoded media content that will be decoded and added to the buffer 5061 is illustrated by the box spanning points B and E. This data segment 1010 is currently in the process of being received and decoded and the duration of media content in the data segment 1010 already received and stored in the decoder 1050 is shown by the box spanning points B and D. The duration of media content in the data segment 1010 that has not yet been received is shown by the box spanning points D and E.

Furthermore, as mentioned in the above, there is a possibility that a portion of the encoded media content in the data segment 1010 defines an independently decodable sub-segment that can be decoded before the entire data segment 1010 is downloaded. This is illustrated by the overlap between t_{b} and tₚ spanning points B and C where part of the data segment 1010 being downloaded can be decoded and delivered to the buffer of the media renderer 1060 already before the entire data segment has been received. Finally, the process of decoding the content takes a finite decoding time t_{c} and no encoded content can be delivered to the playback buffer until it is decoded. The finite decoding time t_{c} is illustrated by the box spanning points E and F.

Assuming the simple scenario described above, the duration of the encoded media content tᵣ between points C and D should be included along with the duration of the decoded media content in the buffer 5061 of the media renderer 1060 if it is estimated that the entire data segment 1010 will be received and decoded prior to the duration t_{b} of the decoded media content has elapsed. Therefore, if it is estimated that t_{b}>t_{d}+t_{c} then the media quality selector 3065 will use t_{b}+tᵣ as the duration of media content contained in the play back buffer. Otherwise, t_{b} will be used by the media quality selector 3065 for quality selection.

In general, estimating the time until all symbols of the data segment 1010 have been received comprises (A) determining the rate at which new symbols are received and (B) determining the number of symbols that should be received prior to the data segment can be decoded.

In a simple case, the number of symbols that should be received is set to the predetermined number of symbols in the data segment 1010 (e.g. 255 or 64) and the rate at which new symbols are received is the average or instantaneous rate at which symbols are received by the network or application-layer decoder 1050.

In some implementations, the determination of A, i.e. the rate at which new symbols are received by the decoder, is modeled using a renewal process. Different types of renewal processes, with one or more parameters, may be used to provide an estimate of when the network or application-layer decoder 1050 will have received all symbols of the data segment 1010. It is possible to calculate the estimate at any point during the download of the data segment 1010.

The rate at which new symbols are received over each network path tends to be relatively constant (although there is some randomness to when new symbols are delivered) and the Poisson process has been shown to be a suitable type of renewal process which can be applied.

A Poisson process is defined by a single parameter λ, which indicates the rate of new arrivals. In the context of streaming encoded media content over one or more network paths, each network path constitutes its own Poisson process. For example, in FIG. 2 there are three network paths and therefore there are three Poisson processes running in parallel, one for each network path. Each process is defined by its own parameter λ₀, λ₁, λ₂ and for multiple Poisson processes it holds that the parameter λ describing the total arrival rate is the sum of each individual parameter λ=λ₀+λ₁+λ₂. An estimate for each λᵢ may be made by recording the time, sᵢ, when the first symbol from source i is received and the number, nᵢ, of symbols received from source i since sᵢ. So, at time t, each λᵢ will be determined by:

$${λ}_{i} = \frac{{n}_{i} - 1}{t - {s}_{i}} \qquad ( 1 )$$

Assuming that the network or application-layer decoder has received n=n₀+n₁+n₂ symbols at time t, and a total of k symbols are needed to start decoding the data segment 1010, an estimate of the time required to received all k symbols can be determined through the following equation:

$$\hat{t} = t + \frac{k - {n}_{0} - {n}_{1} - {n}_{2}}{{λ}_{0} + {λ}_{1} + {λ}_{2}} . \qquad ( 2 )$$

This estimate, \hat{t}, is the mean time that is needed to download all k symbols. If a more conservative estimate is required, the time needed to receive all k symbols with a given certainty 0≤c≤1 can be calculated as

$$\hat{{t}_{c}} = t + \frac{{Q}^{- 1} ( k - {n}_{0} - {n}_{1} - {n}_{2} , z )}{{λ}_{0} + {λ}_{1} + {λ}_{2}} \qquad ( 3 )$$

$$wherein$$

$$z = 1 - \frac{c ( k - {n}_{0} - {n}_{1} - {n}_{2} - 1 ) !}{Γ ( k - {n}_{0} - {n}_{1} - {n}_{2} )} \qquad ( 4 )$$

and Q⁻¹(a, y) is the inverse of the upper incomplete gamma function with respect to x, wherein

$$Q ( a , x ) = \frac{1}{Γ ( a )} {\int }_{x}^{∞} {t}^{a - 1} {e}^{- t} dt \qquad ( 5 )$$

$$and$$

$$Γ ( x ) = {\int }_{0}^{∞} {t}^{x - 1} {e}^{- t} dt \qquad ( 6 )$$

is the Gamma function.

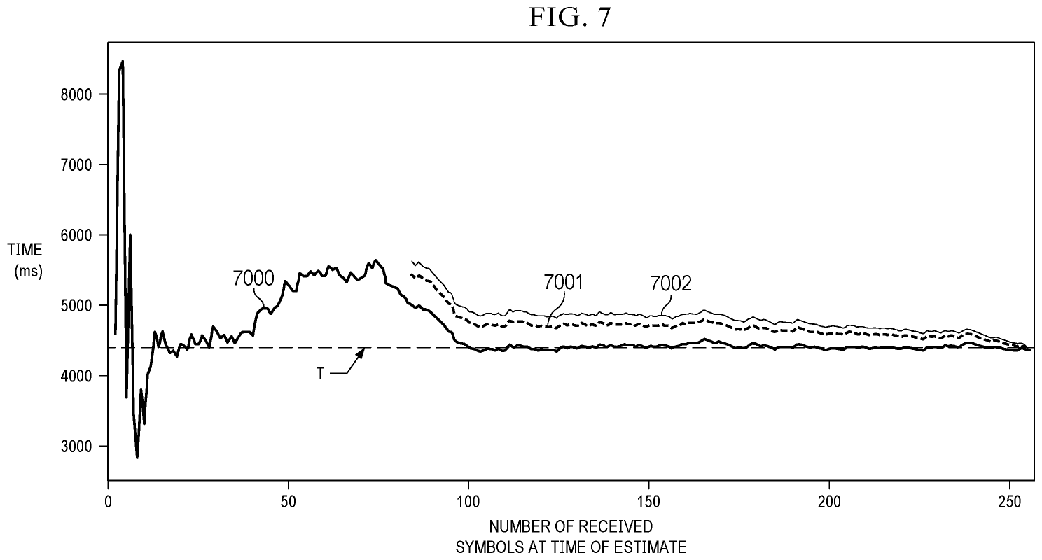

An example of the estimate produced by the above Poisson process is shown in FIG. 7. The X-axis shows the number of symbols that have been received at the time the estimated time was calculated and the Y-axis is the estimated time at which enough symbols have been received to start the decoding process. The horizontal line T is the actual time when the decoder 1050 has received enough symbols and may start to decode the data segment 1010. Graph 7000 is the estimated time \hat{t} from equation (2) in the above. As seen in FIG. 7, the estimate E is more accurate once approximately half of the symbols of the data segment 1010 have been received. Graph 7001 and 7002 depicts the estimated time \hat{t}_{c}, according to equation 5, for receiving all symbols needed to start decoding the data segment with a confidence of c=0.95 and c=0.99 respectively.

In the example depicted in FIG. 5, graph 7000 tends to indicate an estimated time which is slightly less than the actual time T. While this is alleviated with a relaxed certainty level (e.g. with c=0.95), the underestimation of graph 7000 is at least in part a result of the decoder 1050 receiving one or more linearly dependent symbols, which do contribute to the decoding process and does not aid the network or application-layer decoder 1050. Accordingly, the time until a data segment will be fully received and/or decoded may be based on the estimated time extracted from the renewal process described above, optionally the estimated time is calculated at a confidence level other than 1, such as c=0.95 or c=0.99.

In some implementations, the determination of B, i.e. the number of symbols that should be received by the decoder 1050 prior to the decoding of the data segment 1010 can start is based on the probability of the decoder 1050 receiving linearly dependent symbols.

As described in the above, the decoder will often receive one or more linearly dependent symbols (i.e. a symbol which is linearly dependent on at least one of the already received symbols) which do not contribute to the decoding process.

The distribution for when linearly dependent symbols arrive at the decoder 1050 tends to be heavily biased towards the end of the process of receiving the data segment 1010 (e.g., the probability that a symbol is linear dependent is larger when 254 out of 255 symbols have been received than when 100 out of 255 symbols have been received). As a result, an estimate of the expected number of linearly dependent symbols received normally requires an analysis of how the content is encoded and may depend on the type of coding employed.

For example, a Probability Mass Function, PMF, of the number of received linearly dependent symbols based on a large number of data segment downloads can be constructed and the resulting distribution can be used to estimate how many linearly dependent symbols the client device is likely to receive. As an example, analysis of the distribution for the number of linearly dependent symbols received by an xCD-1 decoder when the media content is encoded into 255 symbols in each data segment reveals that the mean number of linearly dependent symbols is three, ten received linearly dependent symbols correspond to a confidence level of 95%, and fifteen received linearly symbols corresponds to a confidence level of 99%.

Accordingly, the number of symbols which should be received by the decoder 1050 to start the decoding process may be estimated as the sum of the number of symbols in the encoded data segment (e.g. 255 which is the minimum number symbols that should be received) and an expected or probable number of linearly dependent symbols which are received when the data segment is downloaded to the decoder (e.g. three symbols in the case of 255 symbol xCD-1 encoding).

It is envisaged that while the mean number of linearly dependent symbols, and the number of linearly dependent symbols at different confidence levels is exemplified for 255 symbol xCD-1 coding in the above, the same analysis may be performed in an analogous manner for any type of network or application-layer encoding with any numbers of symbols in the data segment.

Unless specifically stated otherwise, as apparent from the following discussions, it is appreciated that throughout the disclosure discussions utilizing terms such as “processing”, “computing”, “calculating”, “determining”, “analyzing” or the like, refer to the action and/or processes of a computer hardware or computing system, or similar electronic computing devices, that manipulate and/or transform data represented as physical, such as electronic, quantities into other data similarly represented as physical quantities.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention. Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with instructions for carrying out such a method or element of a method forms a means for carrying out the method or element of a method. Note that when the method includes several elements, e.g., several steps, no ordering of such elements is implied, unless specifically stated. Furthermore, an element described herein of an apparatus embodiment is an example of a means for carrying out the function performed by the element for the purpose of carrying out the embodiments of the invention. In the description provided herein, numerous specific details are set forth. However, it is understood that embodiments of the invention may be practiced without these specific details. In other instances, well-known methods, structures and techniques have not been shown in detail in order not to obscure an understanding of this description.

Thus, while there has been described specific embodiments of the invention, those skilled in the art will recognize that other and further modifications may be made thereto without departing from the spirit of the invention, and it is intended to claim all such changes and modifications as falling within the scope of the invention.

For example, while the media quality selector 3065 is depicted in FIG. 3 and FIG. 5 as a unit which is separated from the decoder 1050 and media renderer 1060 it is envisaged that the media quality selector 3065 may form a part of the media renderer or network or application-layer decoder 1050. For instance, the media renderer 1060 may be included in a conventional VBR media player, e.g. ExoPlayer, which renders media content and accepts a bandwidth and/or buffer measure for the VBR decisions. Accordingly, the bandwidth measure may be replaced with the goodput which is based on the decoder metric and/or the buffer measure may be replaced with the available media content which is based on both the decoding metric and the media renderer metric as described in the above. It is understood that different properties indicated by the decoding metric, and optionally the media renderer metric, may be combined in any way with each property facilitating more accurate quality selection of media content.

1. A method for selecting a quality of media content, the method comprising:
receiving media content of a data segment over at least one network path, the media content being encoded with network or application-layer code;
storing the media content in a network or application-layer decoder, the network or application-layer decoder being configured to decode the media content and provide decoded media content to a buffer associated with a media renderer;
obtaining a decoding metric of the network or application-layer decoder, the decoding metric indicating a property of the decoding process; and
selecting the quality of the media content of subsequent data segments based on the decoding metric.

2. The method according to claim 1, wherein the media content is received over at least two different network paths.

3. The method according to claim 1, wherein the decoding metric indicates an estimated time until the data segment has been fully received.

4. The method according to claim 1, wherein the decoding metric indicates an estimated time until the data segment has been decoded.

5. The method according to claim 3, wherein the media content of the data segment comprises a first number of symbols, the method further comprising:
determining, for each network path, a waiting time between two consecutive received symbols received from the network path; and
determining the estimated time using a renewal process based on the expected time for receiving a predetermined number of symbols with the waiting time(s) and a predetermined confidence level, the predetermined number of symbols being equal to or greater than the first number of symbols.

6. The method according to claim 5, wherein the renewal process is a Poisson process.

7. The method according to claim 5, wherein the predetermined number of symbols is equal to a sum of the first number of symbols and a second number of symbols, the second number of symbols being an expected number of linearly dependent symbols that will be received for the data segment.

8. The method according to claim 1, further comprising:
obtaining, from the media renderer, a media renderer metric indicating a property of the rendering process, wherein selecting the quality of the media content is further based on the media renderer metric.

9. The method according to claim 8, wherein the media renderer metric indicates a playtime of the decoded media content stored in the buffer.

10. The method according to claim 9, further comprising:
determining, based on the playtime, a likelihood of the data segment being fully received and decoded prior to the playtime has elapsed; and
determining the media renderer metric based on the likelihood.

11. The method according to claim 10, further comprising:
determining, based on the likelihood, an available portion of the media content of the data segment;
determining a duration of available media content based on a sum of a duration of the available portion and the playtime; and
determining the media renderer metric based on the duration of available media content.

12. (canceled)

13. The method according to claim 1, wherein the decoding metric further indicates an amount of received media content of the data segment.

14. The method according to claim 1, wherein the decoding metric indicates a data rate at which media content of the data segment is received.

15. The method according claim 1, wherein the decoding metric indicates an amount of overhead of the media content.

16. The method according to claim 15, wherein the media content of the data segment comprises a plurality of symbols, and wherein the amount of overhead indicates a number of received linearly dependent symbols.

17. (canceled)

18. The method according to claim 1, further comprising:
decoding the media content with the network or application-layer decoder to produce the decoded media content;
providing the decoded media content to the media renderer;
storing the decoded media content in the buffer associated with the media renderer; and
rendering, by the media renderer, the media content stored in the buffer.

19. The method according to claim 1, further comprising:
receiving media content of at least one subsequent data segment over the at least one network path, the subsequent data segment comprising media content encoded with the network or application-layer code, the media content having the selected media quality; and
storing the media content of the subsequent data segment in the network or application-layer decoder.

20. A variable quality media system comprising:
a network or application-layer decoder configured to receive media content of a data segment over at least one network path and store the media content, the media content being encoded with network or application-layer code; and
a media renderer, associated with a buffer; and
a media quality selector, configured to obtain a decoding metric of the network or application-layer decoder and select a quality of the media content of subsequent data segments based on the decoding metric, the decoding metric indicating a property of the decoding process,
wherein the network or application-layer decoder is further configured to decode the media content and provide decoded media content to the buffer.

21. A non-transitory computer-readable storage medium storing one or more programs configured to be executed by one or more processors of an electronic device, the one or more programs including instructions for:
receiving media content of a data segment over at least one network path, the media content being encoded with network or application-layer code;
storing the media content in a network or application-layer decoder, the network or application-layer decoder being configured to decode the media content and provide decoded media content to a buffer associated with a media renderer;
obtaining a decoding metric of the network or application-layer decoder, the decoding metric indicating a property of the decoding process; and
selecting the quality of the media content of subsequent data segments based on the decoding metric.

22. (canceled)

23. (canceled)
